(19) United States
(12) Patent Application Publication
(10) Pub. No.: US 2010/0207910 A1
(43) Pub. Date: Aug. 19, 2010

(54) Optical Sensing Screen and Panel Sensing Method

(75) Inventors: Yun-Cheng LIU, Taipei County (TW); Ching-Chun CHIANG, Tao Yuan Shien (TW); Bo-Yi WU, Taipei County (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: Quanta Computer, Inc., Tao Yuan Shien (TW)

(21) Appl. No.: 12/465,180

(22) Filed: May 13, 2009

(30) Foreign Application Priority Data
Feb. 19, 2009 (TW) 098105305

(51) Int. Cl. G06F 3/042

(52) U.S. Cl. 345/175

(57) ABSTRACT

The invention discloses an optical sensing screen for selectively sensing an object and a light pen. A first photo-emitter is disposed in a light pen for emitting a first light. The optical sensing screen includes a panel, an illuminating device, at least two first photo-sensing devices, and a processor. The illuminating device is used to form a background light source. The first photo-sensing devices are used to detect the first light and the background light source. The processor is capable of calculating the coordinate of the object according to the interdicted background light source. When any of the first photo-sensing devices detects the light pen, the processor will drive the illuminating device not to form the background light source and to calculate the coordinate of the first photo-emitter according to the detected first light.

### BACKGROUND OF THE INVENTION

1. Field of the Invention

This invention relates to an optical sensing screen and a panel sensing method for selectively sensing an object and a light pen, and more particularly to the optical sensing screen and the panel sensing method which can be used to be passively inputted with fingers of a user or be actively inputted with a light pen particularly designed.

2. Description of the Related Art

With the advances of technology, electronic products have more functions. People can enter the necessary information into their electronic products with various kinds of input apparatuses (e.g., a keyboard, a mouse, etc.) by different kinds of input methods. To comply with people's requirements to input data quickly and conveniently, the input methods and the modules of electronic products nowadays are getting more diverse, and a touch panel is one of the major technologies. Since users can operate touch panels by inputting with their hands intuitively, more and more electronic products have adopted touch panels as the operating interfaces, so that the requirement of touch panels increases greatly.

In early times, the touch panels in Tablet PCs almost adopted the Electro-Magnetic touch technique of Wacom's company. The touch panel has active electro-magnetic sensor in the liquid crystal module, a pen in which a coil is placed is used to input information. However, the technique can only detect the signal from the pen with the coil, but it cannot be operated by fingers. The resistive module or the surface capacitive module can provide Tablet PCs the function of inputting by touching the panel with fingers.

A resistive touch panel is consisted of an ITO Film, an ITO Glass, and a DOT between the ITO Film and the ITO Glass. By inputting 5V voltage between the ITO Film and ITO Glass, touching the ITO Film to form a hollow by the fingers or a touch pen, generating the variation of the voltage by touching the lower ITO Glass, and transforming the variation of the voltage into digital signals through an A/D controller for a computer to get the coordinates of the X and Y, the goal of positioning can be achieved. The resistive touch panel can be classified into four-wire resistive touch panels and five-wire resistive touch panels according to functions and popularity. The X and Y axis of the four-wire resistive touch panels are distributed at the ITO Film and ITO Glass respectively. When the ITO Film is seriously scraped, the touch panel will not work due to the broken circuit. The five wires resistive touch panels are improved from the four wires resistive touch panels to form a uniform electronic filed on the ITO Glass. The upper ITO Film is a conductor, so the ITO Film can not work just at the position which is scraped and other parts can still be used. But if the lower ITO Glass is damaged, the touch panel still won't work.

Capacitive touch technique is developed 20 years ago, and the 3M Company monopolized the international market of capacitive touch panels in earlier days. In recent years, since the basic patent expired, manufacturers worldwide all joined the field of the capacitive touch panels. The capacitive touch panel improves the feature of the resistive touch panel that poor endurance of being scraped. The outer layer is a thin SiO₂ hardening layer, and the hardness is 7H. The second layer is ITO, and a uniform electronic filed is formed on the glass surface. The working principle is to sense a weak current of a body to achieve the goal of touching. The lowest ITO layer is used to cover and keep the touch panel to work at the prefect environment without interference.

However, no matter it is the resistive or capacitive touch panel, the palm is always put on the screen when the user is writing. Since the movements of the palm and the finger will be sensed at the same time, the sensor can not detect correct input information.

In prior arts, U.S. Pat. No. 4,507,557 discloses a Non-contact X,Y digitizer which uses two dynamic ram imagers, and the detection object has no limitations. Any object or fingers can be detected by the technique. But the technique disclosed by the patent can not be applied to commonly inputting by hands. Since a user usually writes with the palm resting on the screen, the technique disclosed by the patent can not be used to correctly determine the position of the pen point.

Compared with prior arts, the invention provides an optical touch screen which can be used to be passively inputted with fingers of a user or be actively inputted with a light pen which is particularly designed.

### SUMMARY OF THE INVENTION

A scope of the invention is to provide an optical sensing screen for selectively sensing an object and a light pen. A first photo-emitter is disposed in a light pen for emitting a first light. The optical sensing screen includes a panel, an illuminating device, at least two first photo-sensing devices and a processor. The illuminating device is disposed along the edge of the panel for forming a background light source above the panel. The first photo-sensing devices are disposed at the edge of the panel respectively for detecting the first light and the background light source. The processor is electrically connected to the illuminating device and the first photo-sensing devices respectively.

When the object obstructs the background light source, the processor calculates the coordinate of the object according to the obstructed background light source. And when any of the first photo-sensing devices detects the light pen, the processor drives the illuminating device not to form the background light source and to calculate the coordinate of the first photo-emitter according to the detected first light.

Additionally, another scope of the invention is to provide a panel sensing method which can be applied to an optical sensing screen. The optical sensing screen is capable of selectively sensing an object and a light pen. The light pen can be used for emitting a first light. The optical sensing screen includes a screen, an illuminating device, and at least two first photo-sensing devices. The illuminating device can be used for forming a background light source over the panel. The panel sensing method includes the following steps.
(a) using the panel to receive a touch;
(b) determining whether the light pen is detected by the at least one first photo-sensing device, if No, executing step (c), if YES, executing step (e);
(c) driving the illuminating device to form the background light source;
(d) calculating the coordinate of the object according to the obstructed background light source and executing step (a) again;
(e) driving the illuminating device not to form the background light source; and
(f) calculating the coordinate of the first photo-emitter according to the detected first lights and executing step (a) again.

Compared with prior arts, the optical sensing screen of the invention utilizes the writing space formed by the first sensing device and determines whether the light pen appears in the writing space, such that the optical sensing screen can be switched between the passive touch state and the active touch state very smoothly. Therefore, the writing behavior of the user can be correctly detected while writing with the light pen and the palm or arm of the user rested on the screen simultaneously.

The advantage and spirit of the invention may be understood by the following recitations together with the appended drawings.

### BRIEF DESCRIPTION OF THE APPENDED DRAWINGS

FIG. 1 is a schematic diagram illustrating the optical sensing screen of the invention.

FIG. 2 is a schematic diagram illustrating the first embodiment of the optical sensing screen of the invention.

FIG. 3 is a schematic diagram illustrating the second embodiment of the optical sensing screen of the invention.

FIG. 4 is a schematic diagram illustrating the third embodiment of the optical sensing screen of the invention.

FIG. 5 is a flow chart diagram showing the panel sensing method according to an embodiment of the invention.

### DETAILED DESCRIPTION OF THE INVENTION

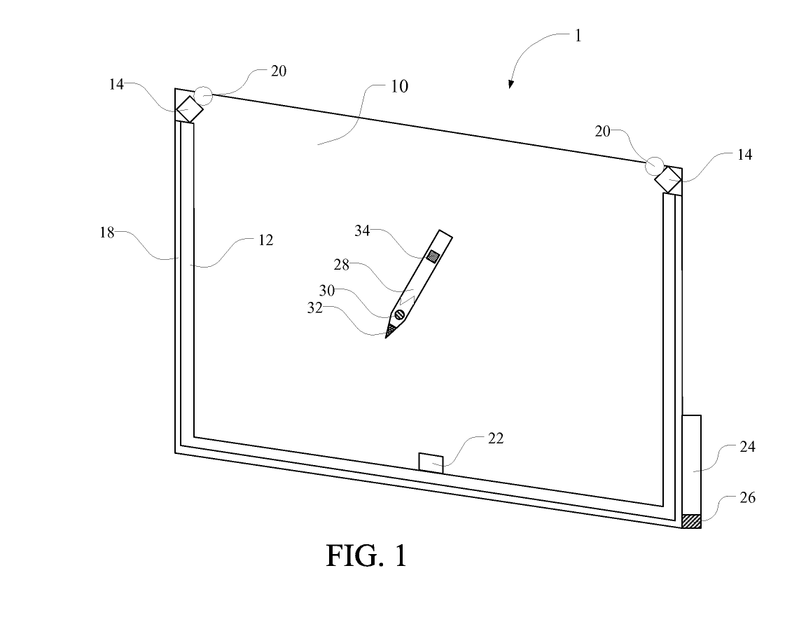

Please refer to FIG. 1. FIG. 1 is a schematic diagram illustrating the optical sensing screen 1 of the invention. The invention provides an optical sensing screen 1 for preventing palm-rejection. The optical sensing screen 1 is capable of selectively sensing an object (no show in the figure) and providing the light pen 28 which can be used to write and chart. The object can be a user's fingers or other substitutes. The first photo-emitter 30 is disposed inside the light 28 for emitting a first light. Wherein, in an embodiment, in order not to influence the color that the user sees from the image shown on the optical sensing screen 1 of the invention, the first photo-emitter 30 can be, but is not limited to, an infrared light-emitting diodes emitting infrared ray which people can not see.

As shown in FIG. 1, the optical sensing screen 1 of the invention includes a panel 10, an illuminating device 12, at least two first photo-sensing devices 14, a processor (no shown in the figure), a second photo-sensing device 22, a pen holder 24, and sensor 26. The illuminating device 12 includes a frame 18 and at least one second photo-emitter 20. Wherein, the frame 18 is disposed along the edge of the panel 10, and a reflection material is disposed at the inner side of the frame 18. The second photo-emitter 20 can also be an infrared light-emitting diode. The at least one second photo-emitter 20 is disposed at the periphery of one of the first photo-sensing devices 14 for emitting a second light toward the frame 18. Thereby, the reflection material which is disposed at the inner side of the frame 18 can be used to scatter the second light emitted from the second photo-emitter 20, so as to form a background light source above panel 10. It is notable that the background light source forms a surface light source above all the panel. Additionally, another embodiment of the illuminating device 12 includes at least one illuminating strip, and the illuminating strips are disposed along the edge of the panel 10 for forming the background light source above the panel 10.

To sum up, according to the optical sensing screen 1 of the invention, the operation modes includes passive touch mode and active touch mode.

As shown in FIG. 1, in the passive touch mode, the optical sensing screen 1 of the invention can form the background light source by the illuminating device 12 and utilizes two or more first photo-sensing devices to sense. When an object (e.g., a finger) touches the optical sensing screen 1, every first photo-sensing device 14 can detect that the background light source is obstructed and then calculates the coordinate of the object according to the obstructed background light source. For example, if there are two first photo-sensing devices 14, the coordinate of the object can be calculated according to the detected background light source obstructed by the object and trigonometric functions.

As shown in FIG. 1, in the active touch mode, the optical sensing screen 1 of the invention can drive the illuminating device 12 not to form the background light source, use the light pen 28 of the first photo-emitter 30 which actively emits the first light to input, and senses by two or more first photo-sensing devices 14. Different from the passive touch mode, the first photo-sensing device 14 detects light pen 28 only, rather than the obstructed background light source. That is to say, all other objects which passively touch the optical sensing screen 1 will be ignored. The light pen 28 can provide the best contrast to increase the precision of positioning since the background light source is not formed. At the same time, the background light source which is not formed will make the effects of the obstructed background light source ignored, so as to achieve the goal of preventing palm-rejection. Additionally, when the light pen 28 touches the optical sensing screen 1, the coordinate of the light pen 28 can also be calculated by the first photo-sensing device 14 according to the detected first light.

As shown in FIG. 1, in the active touch mode, the first photo-sensing devices 14 are disposed at the edge of the panel 10 respectively for detecting the first light and the background light source, and the first photo-sensing devices 14 form a sensing space over the panel 10. When the light pen 28 enters the sensing space, the processor drives the illuminating device 12 not to form the background light source and calculates the coordinate of the first photo-emitter 30 according to the detected first light by the first photo-sensing device 14, which is the first method of switching to the active touch mode according to the optical photo-sensing screen 1 of the invention.

As shown in FIG. 1, the processor is electrically connected to the illuminating device 12 and the first photo-sensing device 14 respectively. The second photo-sensing device 22 is electrically connected to the processor and disposed at the edge of the panel 10. And, the second photo-sensing device 22 can form a sensing space over the panel 10. When the light pen 28 enters the sensing space, the processor drives the illuminating device 12 not to form the background light source and drive the first photo-sensing devices 14 to detect the first light, which is the second method of switching to the active touch mode according to the optical photo-sensing screen 1 of the invention.

As shown in FIG. 1, the pen holder is used to hold the light pen. The sensor 26 is electrically connected to the processor. When the light pen 28 leaves the pen holder 24, the sensor 26 generates a switching signal, and the sensor drives the illuminating device 12 not to form the background light source according to the switching signal and drives the first photo-sensing devices 14 to detect the first light.

Afterwards, the light pen 28 further includes a switch 34 and a pressure sensor 32, as shown in FIG. 1. The switch 34 is electrically connected to the processor. When the switch 34 is switched on, the processor drives the illuminating device 12 not to form the background light source and drives the first photo-sensing devices 14 to detect the first light. The pressure sensor 32 is electrically connected to the processor. When the light pen 28 touches the panel 10, the pressure sensor 32 drives the first photo-emitter 30 to emit the first light and generates a writing signal, the writing signal then be transmitted to the processor, which is the third method of switching to the active touch mode according to the optical photo-sensing screen 1 of the invention.

The foregoing three methods of switching to the active touch mode will be further explained below.

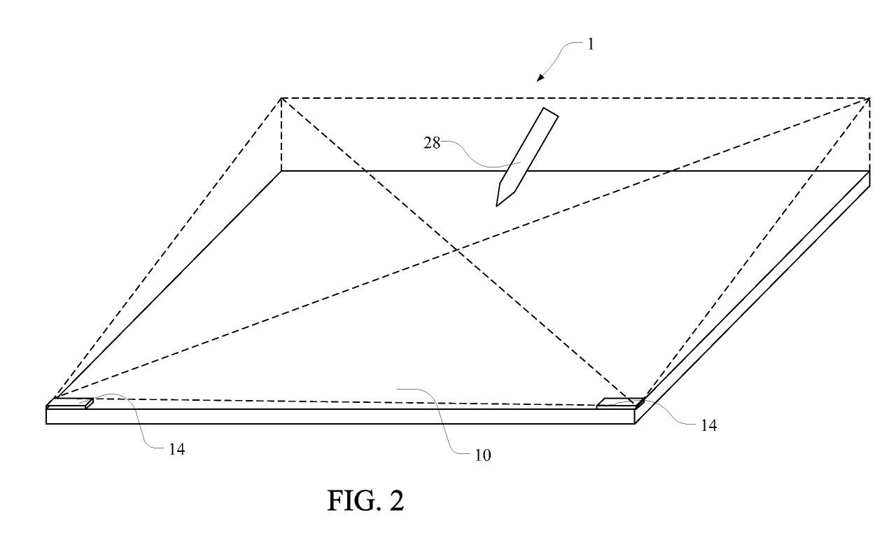

Please refer to FIG. 2. FIG. 2 is a schematic diagram illustrating the first embodiment of the optical sensing screen 1 of the invention. The sensing field of the first photo-sensing device 14 includes a three-dimensional space, and the space can be detected by the first photo-sensing 14 is defined as a writing space, such as the space covered by the dash line in FIG. 2. In the embodiment, the optical sensing screen 1 of the invention includes more than two first photo-sensing devices 14, and all of the sensing spaces of the first photo-sensing devices 14 can be combined and defined to be a writing space. The optical sensing screen 1 is switched between the passive touch mode and active touch mode by detecting whether the light pen 28 is in the writing space. If light pen 28 exists, the optical sensing screen 1 switches to the active touch mode. If light pen 28 does not exist, the optical sensing screen 1 switches to the passive touch mode.

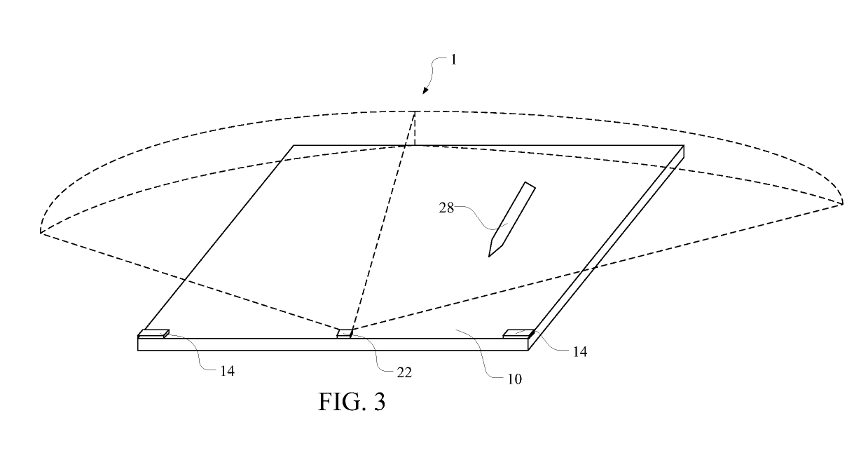

Please refer to FIG. 3. FIG. 3 is a schematic diagram illustrating the second embodiment of the optical sensing screen 1 of the invention. In the embodiment, the optical sensing screen 1 of the invention uses more than one additional second photo-sensing device 22 to form a writing space, and the function of the second photo-sensing devices 22 is different from that of the first photo-sensing device 14 which is used to position. All the sensing fields of the second photo-sensing devices 22 can be combined and defined to be a writing space, such as the space covered by the dash line in FIG. 3. The optical sensing screen 1 is switched between the passive touch mode and active touch mode by detecting whether the light pen 28 is in the writing space. If light pen 28 exists, the optical sensing screen 1 switches to the active touch mode. If light pen 28 does not exist, the optical sensing screen 1 switches to the passive touch mode.

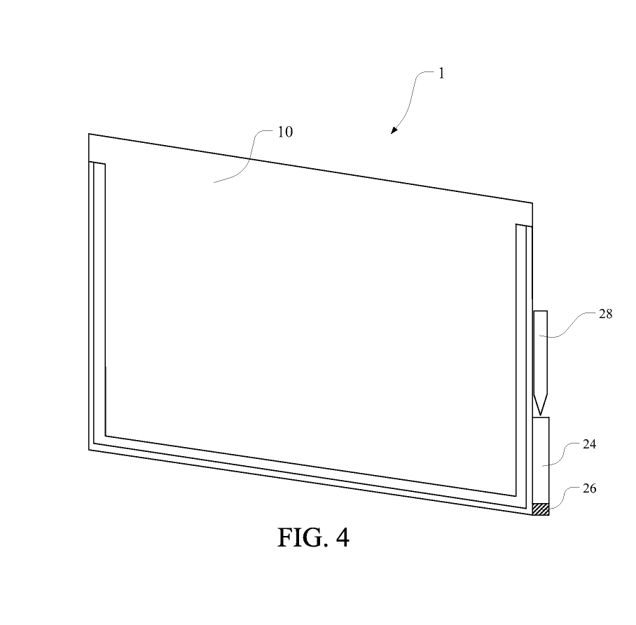

Please refer to FIG. 4. FIG. 4 is a schematic diagram illustrating the third embodiment of the optical sensing screen 1 of the invention. In the embodiment, a pen holder 24 for placing the light pen 28 is disposed to the optical sensing screen 1 of the invention. The pen holder 24 includes a sensor 26. When the light pen 28 is pulled out from the pen holder 24, the optical sensing screen 1 is switched from the passive touch mode to the active touch mode and the user can use the light pen 28 to write. When light pen 28 is received in the pen holder 24, the optical sensing screen 1 is switched to the passive touch mode and inputting by using an object to touch is allowed. The connection between the light pen 28 and processor can be wired or wireless. The light pen 28 actively transmits control signals to the processor and controls the optical sensing screen 1 of the invention to be switched between the passive touch mode and the active touch mode.

Compared with prior arts, the optical sensing screen 1 of the invention forms the writing space by the first sensing device 14 and determines whether the light pen is in the writing space to smoothly switch the optical sensing screen 1 between the passive touch mode and the active touch mode. Therefore, the writing behavior of the user can be correctly detected while writing with the light pen and the palm or arm of the user rested on the screen simultaneously.

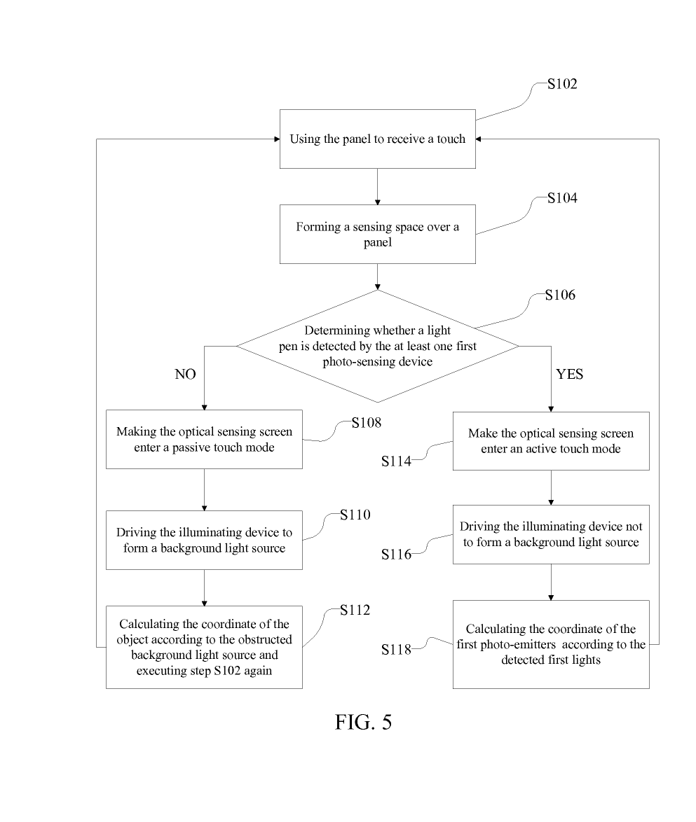

Please refer to FIG. 5. FIG. 5 is a flow chart diagram showing the panel sensing method according to an embodiment of the invention. The invention provides a panel sensing method which can be applied in an optical sensing screen 1 in FIG. 1. The optical sensing screen 1 is capable of selectively sensing an object and a light pen 28, wherein the object can be a finger of a user, and a first photo-emitter 30 is disposed in the light pen 28 for emitting a first light. The first light can be an infrared ray.

The optical sensing screen 1 includes a panel 10, an illuminating device 12 and at least two first photo-sensing devices 14, wherein the illuminating device 12 can form a background light source over the panel 10. The panel sensing method includes the following steps.

Firstly, the panel sensing method according to the invention is executed to perform step S102: using the panel 10 to receive a touch.

Then, the panel sensing method according to the invention is executed to perform step S104: forming a sensing space over the panel 10.

Then, the panel sensing method according to the invention is executed to perform step S106: determining whether the light pen 28 is detected by the at least one first photo-sensing device 14.

If the answer is negative, the panel sensing method according to the invention is executed to perform step S108: making the optical sensing screen enter a passive touch mode.

If the answer is positive, the panel sensing method according to the invention is executed to perform step S114: make the optical sensing screen enter an active touch mode.

The panel sensing method according to the invention is executed to perform step S110: driving the illuminating device 12 to form the background light source, wherein the background light source can be an infrared ray.

The panel sensing method according to the invention is executed to perform step S112: calculating the coordinate of the object according to the obstructed background light source and executing step S102 again. At this time, the optical sensing screen 1 operates at the passive touch mode.

The panel sensing method according to the invention is executed to perform S116: driving the illuminating device not to form the background light source.

The panel sensing method according to the invention is executed to perform S118: calculating the coordinate of the first photo-emitters 30 according to the detected first lights and executing step S102 again. At this time, the optical sensing screen 1 operates at the active touch mode.

Compared with prior arts, the optical sensing screen of the invention utilizes the writing space formed by the first sensing device and determines whether the light pen appears in the writing space, such that the optical sensing screen can be switched between the passive touch state and the active touch state very smoothly. Therefore, the writing behavior of the user can be correctly detected while writing with the light pen and the palm or arm of the user rested on the screen simultaneously.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as being limited only by the metes and bounds of the appended claims.

What is claimed is:

1. An optical sensing screen for selectively sensing an object and a light pen, a first photo-emitter being disposed in a light pen for emitting a first light, the optical sensing screen comprising:
a panel;
an illuminating device, disposed along the edge of the panel, for forming a background light source above the panel.
at least two first photo-sensing devices, disposed at the edge of the panel respectively, for detecting the first light and the background light source; and
a processor being electrically connected to the illuminating device and the first photo-sensing devices;
wherein when the object obstructs the background light source, the processor calculates the coordinate of the object according to the obstructed background light source, and when any of the first photo-sensing devices detects the light pen, the processor drives the illuminating device not to form the background light source and to calculate the coordinate of the first photo-emitter according to the detected first light.

2. The optical sensing screen of claim 1, wherein the illuminating device further comprises:
a frame, disposed along the edge of the panel; and
at least one second photo-emitter for emitting at least one second light toward the frame;
wherein the frame forms the background light source according to the at least one second light.

3. The optical sensing screen of claim 2, wherein a reflection material is disposed at the inner side of the frame for scattering the at least one second light, so as to form the background light source.

4. The optical sensing screen of claim 2, wherein the at least one second photo-emitter is disposed at the periphery of any of the first photo-sensing devices.

5. The optical sensing screen of claim 2, wherein the first photo-emitter and the at least one second photo-emitter are infrared light-emitting diodes.

6. The optical sensing screen of claim 1, wherein the illuminating device further comprises an illuminating strip, disposed along the edge of the panel, for forming the background light source.

7. The optical sensing screen of claim 1, wherein the first photo-sensing devices forms a sensing space over the panel, when the light pen enters the sensing space, the processor drives the illuminating device not to form the background light source and calculates the coordinate of the first photo-emitter according to the detected first light.

8. The optical sensing screen of claim 1, further comprising a second photo-sensing device, electrically connected to the processor and disposed at edge of the panel, the second photo-sensing device forming a sensing space over the panel, when the light pen enters the sensing space, the processor drives the illuminating device not to form the background light source and drives the first photo-sensing devices to detect the first light.

9. The optical sensing screen of claim 1, further comprising:
a pen holder for the light pen to be placed; and
a sensor, electrically connected to the processor, wherein when the light pen leaves the pen holder, the sensor generates a switching signal, the sensor drives the illuminating device not to form the background light source according to the switching signal and drives the first photo-sensing devices to detect the first light.

10. The optical sensing screen of claim 1, wherein the light pen further comprises a switch, electrically connected to the processor, when the switch is switched on, the processor drives the illuminating device not to form the background light source and drives the first photo-sensing devices to detect the first light.

11. The optical sensing screen of claim 1, wherein the light pen further comprises a pressure sensor, electrically connected to the processor, when the light pen touches the panel, the pressure sensor drives the first photo-emitter to emit the first light and generates a writing signal, the writing signal then is transmitted to the processor.

12. The optical sensing screen of claim 1, wherein the object is a finger of a user.

13. A panel sensing method, applied in an optical sensing screen, the optical sensing screen being capable of selectively sensing an object and a light pen, the light pen being for emitting a first light, the optical sensing screen comprising a screen, an illuminating device, and at least two first photo-sensing devices, the illuminating device being for forming a background light source over the panel, the panel sensing method comprising the steps of:
(a) using the panel to receive a touch;
(b) determining whether the light pen is detected by the at least one first photo-sensing device, if No, executing step (c), if YES, executing step (e);
(c) driving the illuminating device to form the background light source;
(d) calculating the coordinate of the object according to the obstructed background light source and executing step (a) again;
(e) driving the illuminating device not to form the background light source; and
(f) calculating the coordinate of the first photo-emitters according to the detected first lights and executing step (a) again.

14. The panel sensing method of claim 13, wherein step (b) further comprising the steps of:
(b1) forming a sensing space over the panel; and
(b2) determining whether the light pen enters the sensing space, if NO, executing step (c), if YES, executing step (e).

15. The panel sensing method of claim 13, wherein the object is a finger of a user.

16. The panel sensing method of claim 13, wherein the first light and the background light source are infrared rays.
